(19) United States
(12) Patent Application Publication
(10) Pub. No.: US 2026/0089418 A1
(43) Pub. Date: Mar. 26, 2026

(54) PROBE ANTENNA USING GROUND LINE

(71) Applicant: Skyworks Solutions, Inc., Irvine, CA (US)

(72) Inventors: Alexander August Arthur Hakkola, Maple (CA); Ken Andrew Strickland, Austin, TX (US); Carl Harry Alelyunas, Austin, TX (US); Thomas Glen Ragan, Austin, TX (US); Adam Michael Zaharias, Austin, TX (US)

(21) Appl. No.: 19/338,725

(22) Filed: Sep. 24, 2025

Related U.S. Application Data
(60) Provisional application No. 63/698,692, filed on Sep. 25, 2024.

(51) Int. Cl. H04R 1/06; G10K 11/178

(52) U.S. Cl. CPC H04R 1/06; G10K 11/17827; H04R 2499/13

(57) ABSTRACT

A vehicle radio system comprising a radio frequency antenna configured to detect an audio signal. The system includes a tuner circuit and an antenna connector having a first connection coupled to the radio frequency antenna, a second connection coupled to the at least one tuner circuit to provide the audio signal to the at least one tuner circuit, and a third connection coupled to a chassis ground connection of a vehicle. A ground path extends from the chassis ground connection to the tuner circuit, where the ground path detects a noise signal and communicates the noise signal to the tuner circuit. An audio processor processes the audio signal and the noise signal to generate a noise-reduced audio signal.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

Radio receivers are implemented in a variety of applications. While some broadcast radio signals are transmitted with analog coding (e.g., amplitude modulation (AM) and frequency modulation (FM) signals), other terrestrial and satellite wireless communication systems use digital encoding. Examples of digital radio systems include systems that can be implemented in accordance with National Radio System Committee (NRSC-5C, also known as HD™ radio), Digital Audio Broadcasting (DAB), Digital Radio Mondiale (DRM), Convergent Digital Radio (CDR), or another suitable digital radio standard.

One common implementation of a radio is within an automotive environment. Highly immersive automobile entertainment options are becoming more readily available. These entertainment options can include a head unit, typically located around the vehicle dashboard. The dashboard is often implemented with one or more displays that provide a user interface for the user to interact with the entertainment system. One or multiple radio frequency antennas can be located at vehicle locations like a rear window or rear quarter panel. The radio frequency antennas can often pick up undesired signal from a variety of noise sources.

### SUMMARY

In some aspects, the techniques described herein relate to a vehicle radio system including: a radio frequency antenna configured to detect an audio signal; at least one tuner circuit; an antenna connector having a first connection coupled to the radio frequency antenna, a second connection coupled to the at least one tuner circuit to provide the audio signal to the at least one tuner circuit, and a third connection coupled to a chassis ground connection of a vehicle; a ground path extending from the chassis ground connection to the at least one tuner circuit, the ground path configured to detect a noise signal and communicate the noise signal to the at least one tuner circuit; and an audio processor coupled to the at least one tuner circuit and configured to process the audio signal and the noise signal to generate a noise-reduced audio signal.

In some aspects, the techniques described herein relate to a vehicle radio system wherein the at least one tuner circuit includes a first tuner circuit and a second tuner circuit, the first tuner circuit coupled to the radio frequency antenna and the second tuner circuit coupled to the ground path.

In some aspects, the techniques described herein relate to a vehicle radio system wherein the audio processor includes one or more microprocessors.

In some aspects, the techniques described herein relate to a vehicle radio system wherein the at least one tuner circuit and the audio processor are included in a common packaging in a radio unit.

In some aspects, the techniques described herein relate to a vehicle radio system further including a remote tuner module including the at least one tuner circuit and further including a head unit having the audio processor.

In some aspects, the techniques described herein relate to a vehicle radio system further including one or more loudspeakers configured to output audible audio in response to the noise-reduced audio signal.

In some aspects, the techniques described herein relate to a vehicle radio system further including a second radio frequency antenna configured to detect a second audio signal, a second antenna connector, and a second ground path, the second antenna connector having a first connection coupled to the second radio frequency antenna, a second connection coupled to the at least one tuner circuit to provide the second audio signal to the at least one tuner circuit, and a third connection coupled to a second chassis ground connection of the vehicle, the second ground path extending from the second chassis ground connection to the at least one tuner circuit.

In some aspects, the techniques described herein relate to a vehicle radio system wherein the second ground path is configured to detect a second noise signal and communicate the second noise signal to the at least one tuner circuit, and the audio processor is configured to process the audio signal, the second audio signal, the noise signal, and the second noise signal to generate the noise-reduced audio signal.

In some aspects, the techniques described herein relate to a vehicle radio system wherein the noise signal includes noise generated by one or more of an engine, alternator, motor, or pulse-width-modulated driver of the vehicle.

In some aspects, the techniques described herein relate to a vehicle radio system wherein the ground path includes primarily the chassis of the vehicle.

In some aspects, the techniques described herein relate to a method of reducing noise in an audio signal detected by a vehicle radio system, the method including: detecting an audio signal with a radio frequency antenna of the vehicle radio system; detecting a noise signal with a ground path that is connected to a ground connection of a vehicle; communicating the audio signal to at least one tuner circuit of the vehicle radio system; communicating the noise signal to the at least one tuner circuit via the ground path; and processing the audio signal and the noise signal with an audio processor to generate a noise-reduced audio signal.

In some aspects, the techniques described herein relate to a method wherein the at least one tuner circuit includes a first tuner circuit and a second tuner circuit, the first tuner circuit coupled to the radio frequency antenna and the second tuner circuit coupled to the ground path.

In some aspects, the techniques described herein relate to a method wherein the audio processor includes one or more microprocessors.

In some aspects, the techniques described herein relate to a method wherein the at least one tuner circuit and the audio processor are included in a common packaging in a radio unit.

In some aspects, the techniques described herein relate to a method further including a remote tuner module including the at least one tuner circuit and a head unit including the audio processor.

In some aspects, the techniques described herein relate to a method further including outputting audible audio with one or more loudspeakers in response to the noise-reduced audio signal.

In some aspects, the techniques described herein relate to a method wherein communicating the audio signal to the at least one tuner circuit includes communicating the audio signal from the radio frequency antenna to a first connection of an antenna connector, and communicating the audio signal from a second connection of the antenna connector to the at least one tuner circuit, the antenna connector including a third connection connected to the ground path.

In some aspects, the techniques described herein relate to a method wherein the ground connection is to a chassis of a vehicle.

In some aspects, the techniques described herein relate to a method wherein the ground path includes primarily the chassis of the vehicle.

In some aspects, the techniques described herein relate to a vehicle radio unit including: at least one tuner circuit configured to receive an audio signal detected by a radio frequency antenna of a vehicle, and to receive a noise signal detected by a ground path connected to a chassis ground connection of the vehicle; an audio processor coupled to the at least one tuner circuit and configured to process the audio signal and the noise signal to generate a noise-reduced audio signal.

In some aspects, the techniques described herein relate to a vehicle radio unit wherein the at least one tuner circuit includes a first tuner circuit and a second tuner circuit, the first tuner circuit coupled to the radio frequency antenna and the second tuner circuit coupled to the ground path.

In some aspects, the techniques described herein relate to a vehicle radio unit wherein the audio processor includes one or more microprocessors.

In some aspects, the techniques described herein relate to a vehicle radio unit wherein the at least one tuner circuit and the audio processor are included in a common packaging in a radio unit.

In some aspects, the techniques described herein relate to a vehicle radio unit further including a remote tuner module including the at least one tuner circuit and a head unit coupled to the remote tuner module and that includes the audio processor.

### BRIEF DESCRIPTION OF THE DRAWINGS

FIG. 1 shows an automotive radio system including a radio frequency antenna and a separate noise probe antenna.

FIGS. 2A and 2B show examples of automotive radio systems where a ground path is used to detect noise, and the radio system uses the detected noise to improve signal-to-noise ratio in an audio signal detected by a radio frequency antenna.

FIG. 3 is a flow chart depicting a method of cancelling noise in an automotive radio system, where the noise is detected by a ground path.

FIGS. 4 and 5 show embodiments of additional automotive radio systems where a ground path is used to detect noise, where the radio system includes a separate head unit and remote tuner module.

FIG. 6 is a schematic block diagram of a digital radio baseband processor according to certain embodiments.

### DETAILED DESCRIPTION

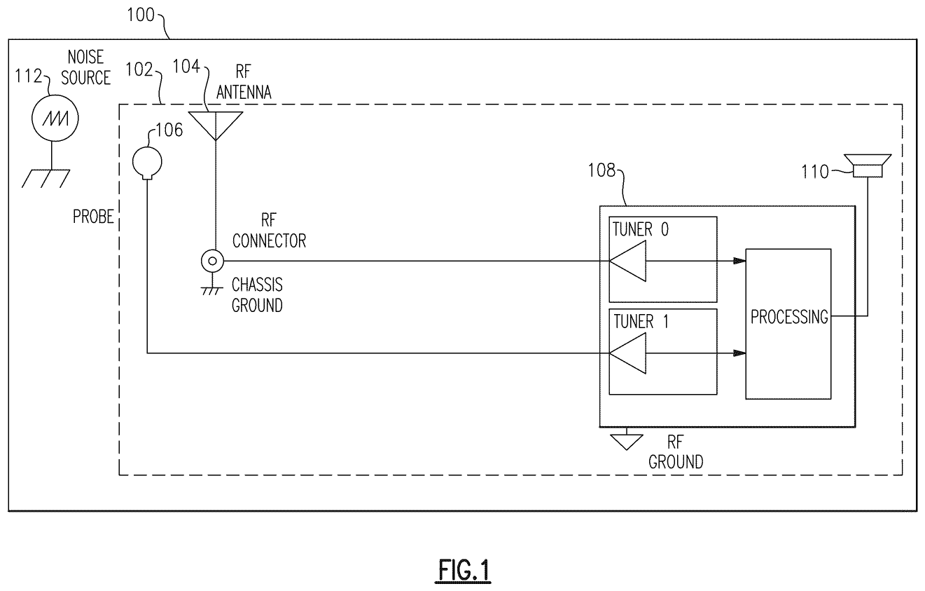

FIG. 1 shows an automobile 100 including an automotive radio system 102 having a radio frequency antenna 104 and a separate noise probe antenna 106. The illustrated radio system 102 includes a radio receiver unit 108 coupled to the radio frequency antenna 104 and the noise probe antenna 106.

The radio receiver unit 108 is configured to receive an audio signal detected by the radio frequency antenna 104, receive a noise signal detected by the noise probe antenna 106, process the audio signal and the noise signal to cancel noise in the audio signal, and output a noise-cancelled audio signal to one or more automobile speakers 110 or other audio playback devices.

Having a noise probe antenna 106 separate from the radio frequency antenna 104, such as is illustrated in FIG. 1, can be helpful for detecting noise from one or more noise sources 112. The noise sources 112 can include vehicle components such as a vehicle engine, alternator, motor, pulse-width-modulated driver, other vehicle electrical systems, noise sources external to the vehicle, or a combination of any of these or other noise sources.

But having a separate probe antenna 106 can also be expensive and involve additional manufacturing time to make additional connections to the probe antenna 106 and add cabling from the probe antenna 106 to the receiver.

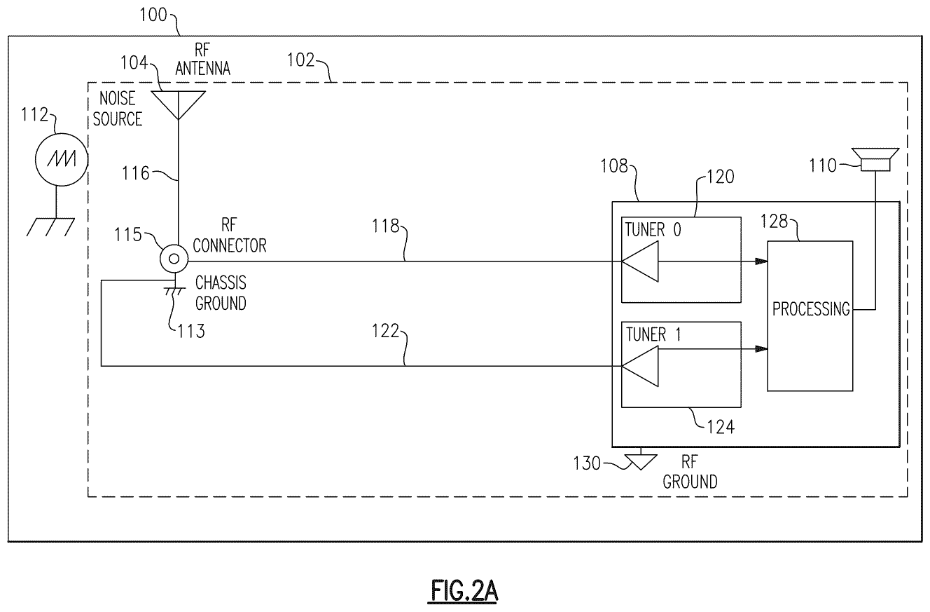

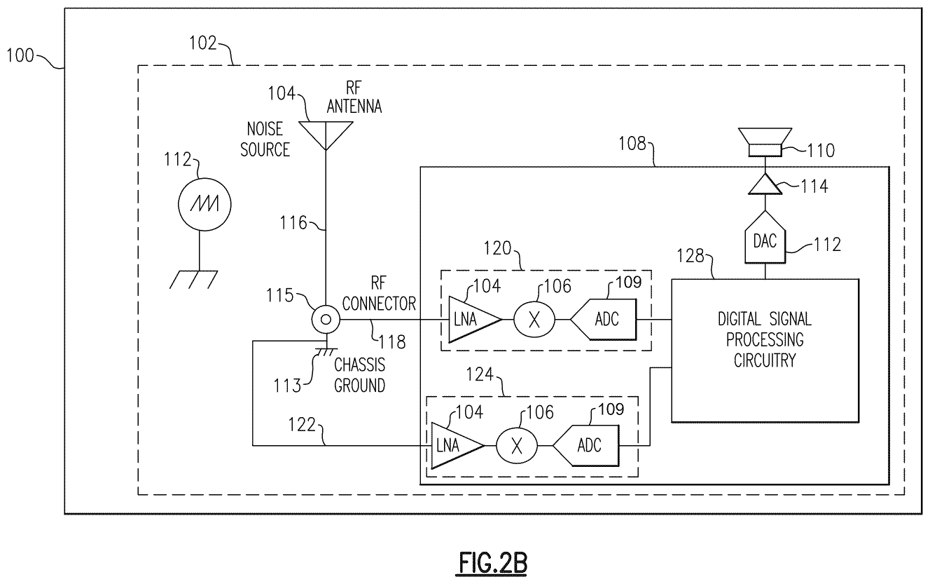

FIG. 2A shows an automotive radio system 100 where a ground path 122 is used to detect noise. The radio frequency antenna 104 can be used to detect any appropriate radio signal, including AM, FM, National Radio System Committee (NRSC-5C, also known as HD™ radio), DAB, DRM, CDR, or another digital radio standard. Some amount of noise can couple to the radio frequency antenna 104, despite care being taken to reduce such coupling.

In the illustrated embodiment, the radio frequency system 102 includes a radio frequency connector 115 with a first connection (e.g., a port or other interface) connected via a first conductive path 116 to the radio frequency antenna 104. Depending on the implementation, the first conductive path 116 can be an antenna stem or other part of the antenna itself, or a wire, lead, coaxial cable, or other conductive element. For example, in some embodiments, the first conductive path 116 is an antenna stem, which threads onto or otherwise fastens to the corresponding first connection of the connector 115.

The radio frequency connector 115 also has a second connection (e.g., a port or other interface) connected via a second conductive path 118 to a first tuner 120 of the radio receiver unit 108. Depending on the implementation, the second conductive path 118 can be a wire, coaxial cable or other conductive element. For example, in some embodiments, the second conductive path 118 includes a coaxial cable that threads onto or otherwise fastens to the corresponding second connection of the connector 115, to connect to the antenna 104. In some embodiments, the radio unit 108 can reside on one or more integrated circuit (IC) dies mounted on a printed circuit board within a radio housing. In such cases, a wire or cable electrically coupled to the input to the first tuner 120 can extend from the radio housing to the second connection 118, either directly or via one or more intermediate wires or cables.

The illustrated connector 115 additionally includes a third connection (e.g., a port or other interface) connected to a vehicle ground connection point 113. In this way, the third connection provides an interface for grounding the antenna 104. Moreover, the third port and the ground connection point 113 are coupled via a ground path 122 to a second tuner 124 of the radio receiver unit 108. In the illustrated embodiment, the ground connection point 113 is a connection point on the chassis of the automobile or other vehicle 100. In one embodiment, a ground lead wire extends from the connector 115 and fastens to a ground point 113 on the chassis, e.g., via a metal bolt, and the ground path 122 is a ground wire extending from the ground connection point 113 to the second tuner 124. As explained above, the radio unit 108 can reside on one or more integrated circuit (IC) dies mounted on a printed circuit board within a radio housing. In such cases, a wire or cable electrically coupled to the input to the second tuner 124 can extend from the radio housing to the ground path 122, either directly or via one or more intermediate wires or cables.

The ground path 122 can be implemented differently in other embodiments. For instance, in some embodiments a lead wire extending from the third connection of the antenna connector 115 can connect to the chassis ground connection point 113 at a first end of the ground path 122, and the second tuner 124 can be connected at the other end of the ground path 122, e.g., to a second ground connection point on the chassis that is in closer proximity to the radio unit 108 than the first ground connection point 113. One or more wires or cables extending from the second ground connection point can connect a radio unit housing that contains the second tuner 124, to connect to the input of the second tuner 124 (e.g., residing on an IC within the housing). In this manner, the ground connection path 122 primarily comprises the chassis itself, extending between the first and second chassis connection points.

As shown, the remote receiver unit 108 can be connected to a radio frequency ground 130, e.g., via a ground pin of an integrated circuit package or circuit board containing the remote receiver unit 108.

The first tuner unit 120 can include appropriate circuitry for processing an audio signal detected by the radio frequency antenna 104, and the second tuner 124 can similarly include appropriate circuitry for processing a noise signal detected by the ground connection path 122. For instance, the first and second tuner units 120, 124 can include some or all of amplification circuitry, gain circuitry, analog to digital conversion circuitry, filtering circuitry, and the like, for providing a processed digital signal to the digital processing circuitry 128.

The digital processing circuitry 128 can comprise one or more microprocessors, field-programmable gate arrays, or the like, and can execute software or firmware for processing the digital audio signal received from the first tuner unit 120 and the noise signal received from the second tuner unit 124. For example, the digital processing circuitry 128 in one embodiment includes a digital signal processor (DSP). In other embodiments, the digital processing circuitry comprises an application-specific integrated circuit (ASIC).

The digital processing circuitry 128 can be configured to apply an appropriate algorithm to cancel the noise signal or a substantial portion thereof from the audio signal, such as through a subtraction operation where a scaling factor is applied to the noise signal before subtracting it from the audio signal. In some embodiments, the digital processing circuitry applies a normalized constant phase algorithm with normalized amplitude (NCPA-NA).

In the embodiment of FIG. 2A, the ground path 122 can advantageously function as a noise antenna by detecting undesired noise signal from one or more noise sources and providing the noise signal to the radio receiver unit 108. For instance, where the ground path 122 is connected to chassis ground, the ground path 122 can serve as a particularly effective noise antenna because the chassis can be in proximity to common noise sources, such as a vehicle engine, motor, alternator, or other electrical systems of the vehicle. Moreover, using the ground path 122 as the noise antenna also provides a cost savings benefit because it can replace a separate probe antenna and/or corresponding cabling or other componentry, and reduce corresponding manufacturing and installation time.

A variety of alternative configurations are possible. As an example, the audio signal and noise signal can be received by the same tuner unit instead of separate tuner units. In some implementations, the cancellation of the noise signal from the audio signal can be done outside of the digital processing circuitry 128, such as in cancellation circuitry residing within a tuner unit, by analog cancellation circuitry residing between tuner units 120, 124 and the digital signal processing circuitry 128, or by digital circuitry such as another processor positioned between the tuner units 120, 124 and the digital processing circuitry 128.

FIG. 2B illustrates additional detail relating to embodiments of the first and second tuners 120, 124. The illustrated radio tuner units 120, 124 can each include a low noise amplifier (LNA) 104, a mixer 106, and an analog-to-digital converter (ADC) 109. In some instances, the tuner units 120, 124 can include additional circuit elements, such as one or more filters, amplifiers with automatic gain control, etc. The LNA can amplify a received radio frequency audio or noise signal. The mixer 106 can downconvert the amplified radio frequency audio or noise signal. The downconverted signal generated by the mixer 106 can be a low-intermediate frequency (IF) signal or a zero-IF signal, for example. The downconverted signal can include an in-phase/quadrature phase (IQ) signal. The ADC 109 can digitize the downconverted audio or noise signal into a digital signal.

The digital signal processing circuitry 128 can process the digital audio signal provided by the first tuner unit 120 and the digital noise signal generated by the second tuner unit 124, and provide a processed, reduced-noise digital audio signal to a digital-to-analog converter (DAC) 112. For example, the radio receiver unit 108 can process a received digital radio signal to perform noise reduction or cancellation in accordance with any suitable principles and advantages disclosed herein. The DAC 112 can provide an analog signal for amplification by the amplifier 114 and then audible output by a loudspeaker 110 in response to the amplified signal. While FIG. 2B shows one loudspeaker, audio can be output from any suitable number of speakers.

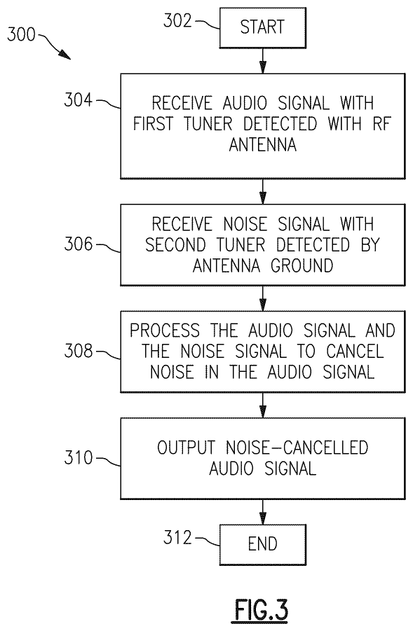

FIG. 3 is a flow chart depicting a method 300 of cancelling noise in an automotive radio system, where the noise is detected by a radio frequency ground path. While the flow chart of FIG. 3 will be described in the context of the system 100 of FIG. 2B, the method 300 can be used with other compatible systems including any of those shown and described herein, e.g., with respect to FIGS. 2A, 4, and 5.

At block 302 the method starts. For example, a user may interact with a user interface of a vehicle entertainment system to turn on the radio system 102. At block 304, the method 300 includes receiving an audio signal with a first tuner detected with a radio frequency antenna. For example, referring to FIG. 3, the radio frequency antenna 104 can detect a radio frequency signal, which is communicated to the first tuner 120 via a conductive path that includes the first connection 116, the radio frequency antenna connector 115, and second connection 118.

At block 306, the method 300 includes receiving a noise signal with a second tuner, where the noise signal was detected by a radio frequency ground path. For example, a third connection of the radio frequency antenna connector 115 can be connected to a ground point 113 of a chassis of the vehicle 100. Noise detected by a ground path 122 coupled to the ground connection point 113 travels along the ground path to the second tuner 124.

At block 308, the method 300 includes processing the audio signal and the noise signal to cancel noise from the audio signal. For example, the tuner units 120, 124 can apply amplification, mixing, analog-to-digital conversion, gain adjustment, and any other appropriate processing. Thus, the first tuner unit 120 can output a digital signal corresponding to the detected audio signal prior to noise cancellation, and the second tuner unit 124 can output a digital signal corresponding to the detected noise signal. At block 308, the digital processing circuitry 128 can additionally apply a noise cancellation algorithm to the digital signals in addition to other appropriate audio processing (e.g., filtering, equalization, volume adjustment, etc.). In this manner, the digital processing circuitry 128 can use the noise detected by ground path 122 to generate a noise-reduced or noise-cancelled version of the audio signal detected by the radio frequency antenna 104.

At block 310, the method 300 can include outputting the noise-reduced or noise-cancelled audio signal. For example, the digital processing circuitry 128 can output the noise-reduced audio signal to a digital-to-analog converter 112, which outputs an analog audio signal for playback by the loudspeaker 110 after amplification by the amplifier 114.

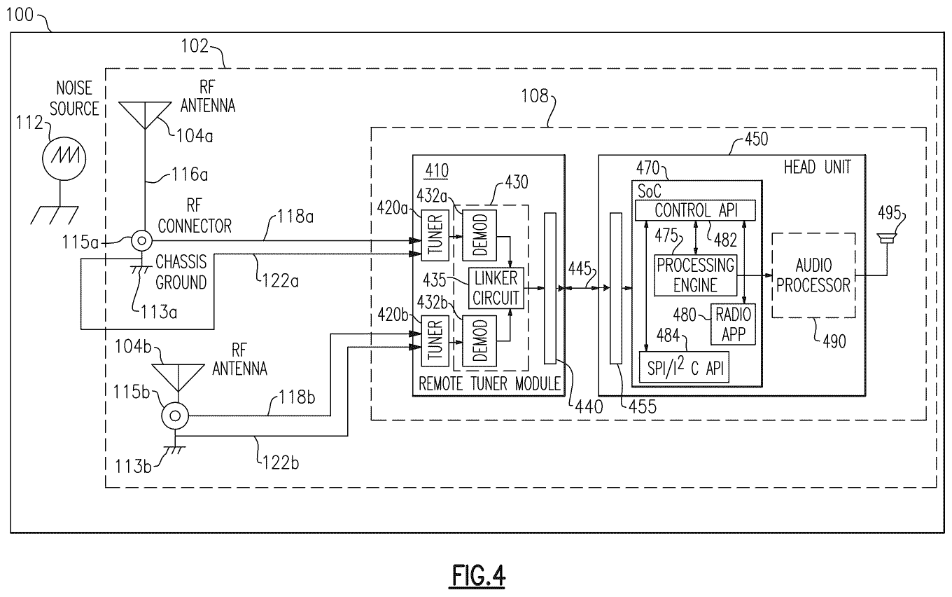

FIG. 4 shows an embodiment of an automotive radio system 102 of a vehicle 100. The radio system 102 can be like those of FIGS. 2A and 2B, except that the system 102 includes multiple antennas 104a, 104b and corresponding antenna ground paths 122a, 122b used to detect noise. Moreover, the radio receiver unit 108 includes a separate head unit 450 and remote tuner module (RTM) 450, unlike the systems of FIGS. 2A and 2B. Such a configuration can help reduce wiring among other advantages.

The RTM 410 may be implemented with at least one circuit board and may be affixed in a given location of a vehicle, such as a rear portion of the vehicle, relatively close to one or more antennas which couple to RTM 410. RTM 410 may be located remotely from the radio head unit 450. As illustrated, RTM 410 can include multiple tuners 420a, 420b that may be adapted on a circuit board, along with additional components.

In the illustrated embodiment, the radio system 102 includes two radio frequency antennas 104a, 104b configured to detect audio signals. The system 102 includes a radio frequency connector 115a, 115b for each radio frequency antenna 104a, 104b. Like the antennas and connectors of FIGS. 2A and 2B, each connector 115 can have a first connection (e.g., a port or other interface) coupled via a first conductive path 116a, 116b to the radio frequency antenna 104a, 104b, a second connection (e.g., a port or other interface) coupled via second conductive path 118a, 118b to a corresponding one of the tuners 420a, 420b, and a third connection (e.g., a port or other interface) coupled to a chassis ground point 113a, 113b and via a ground path 122a, 122b to a corresponding tuner 420a, 420b of the radio receiver unit 108. The ground connection points 113a, 113b can be separate connection points on the chassis of the automobile 100. Or, in some implementations, the same point on the chassis can be used for both connection points 113a, 113b. The RTM 410 and/or the head unit 450 can each be connected to a radio frequency ground, e.g., via a ground pin of an integrated circuit package or circuit board.

Unlike the systems of FIGS. 2A and 2B, in the configuration illustrated in FIG. 4, the audio signal detected by each radio frequency antenna 104a, 104b and the noise signal detected by each corresponding ground connection path 122a, 122b are coupled to the same corresponding tuner 420a, 420b. In other implementations, the audio signal and the noise signal can be connected to different tuners, like in the radio systems 102 shown in FIGS. 2A and 2B.

In various implementations, the automobile system 100 may be adapted with more or fewer radio frequency antennas or ground path connections to the RTM 410. The radio frequency antennas 104a, 104b can be configured to receive digital radio communications in accordance with any of the analog or digital radio standards described herein.

Received RF audio signals detected by each antenna 104a, 140b and RF noise signals detected by each ground path 122a, 122b are in turn provided to corresponding tuners 420a, 420b (generically tuners 420). The tuners 420 may be implemented in one or more integrated circuits residing on a circuit board of the RTM 410. The tuners 420 each may be a multi-tuner multi-band tuner to receive and process RF signals of different bands. Like the tuners 120, 124 of FIGS. 2A and 2B, the tuners 420 may include radio frequency front end circuitry such as an LNA, gain control circuitry, mixer, filter, digitizer and so forth that operate to receive and process the radio frequency signal and generate a resulting digitized signal at a downconverted frequency. For example, the tuners 420 may be configured to output signals at baseband, zero intermediate frequency (ZIF) or other downconverted level. In embodiments, tuners 420 may output such signals in digitized form.

In addition, one or more of the tuners 420 may be configured to receive and process analog radio signals, e.g., AM and FM signals. In such embodiments, tuners 420 further may be configured with complete radio receiver circuitry to demodulate these AM and FM signals into demodulated audio signals, and to generate audio output signals, e.g., according to a given digital format such as an Inter-IC Sound (I2S) format. In different implementations, the tuners 420 may be configured to receive, process and demodulate AM and FM and possibly also weather band signals. In addition, each of the tuners 420 may be configured to receive and process additional RF signals into downconverted digital streams, including digital streams for HD radio, DAB radio and so forth, e.g., in the form of digital I/Q data. Depending upon the particular configuration, the tuners 420 thus may be adapted to output one or more audio streams as well as one or more digital I/Q data streams for one or more radio standards.

For digital formats, resulting digitized signals are provided to a demodulator 430. And as described further below, one or more audio streams output from tuners 420 may be provided to a demodulator 430. In embodiments, demodulator 430 may be implemented as a standalone IC adapted in a particular layout portion of the circuit board of RTM 410. The illustrated demodulator 430 includes multiple demodulation circuits 432a, 432b (generically demodulator circuits 432), each to receive incoming signal information from one of tuners 420. In turn, demodulator circuits 432 operate to demodulate the incoming signals, which are received in a modulated form. In general, demodulator circuits 432 may include various circuitry including asynchronous sample rate converters, decoder circuitry and so forth. Demodulator circuits 432 output demodulated signals, which are provided to a linker circuit 435.

In embodiments, linker circuit 435 may seamlessly link demodulated signals of the two paths when appropriate. For example, for DAB radio communication, a given radio station may transmit at multiple frequencies, possibly including an FM channel and one or more DAB channels carrying the same audio content. As a vehicle drives along a route, it may first tune to the radio station at a first frequency (e.g., as received and processed within tuner 420a and demodulator circuit 432a). However, as the vehicle continues along its route assume that this signal becomes degraded. As a result, better signal quality may be realized via signals received at another frequency via tuner 420b and demodulator circuit 432b. As such, linker circuit 435 may seamlessly transition its output to be directed from a given one of demodulator circuits 432 to the other in a seamless fashion (e.g., by providing buffering resources or so forth) such that the transition from one frequency to another occurs seamlessly to a listener. Note that in some cases, linker circuit 435 may transition output from one to the other in a less than completely seamless manner. In other use cases, such as where tuners 420 are handling independent channels (such as for background, data or so forth), linker circuit 435 may operate in a routing or pass through mode in which demodulated information from both of tuners 420 can be output, without performing any linking.

In still further use cases, such as for HD radio, linker circuit 435 may in this routing or pass through mode pass through an HD radio signal that itself may be a blend of an HD radio stream and an analog audio stream. To this end, the audio stream output from tuner 420 may be provided directly to a corresponding demodulator circuit 432 for use in blending. Or in other cases, demodulated analog audio output from tuner 420 may first be provided to linker circuit 435 and then routed back to demodulator circuit 432 for blending. Note that in cases blending between analog audio and a primary service (MPS) may occur seamlessly where an automatic level and time alignment technique is used, which may be performed in a corresponding demodulator circuit 432. In other cases, a switch between analog audio and a primary service may occur without blending, such as based on signal metrics.

Demodulated signals output from demodulator 430 are provided to a gateway circuit, which can be a serializer configured to receive the demodulated signals and convert them into a serial format for communication to head unit 450. In various embodiments, head unit 450 may be implemented within a different portion of the vehicle, e.g., closely located to an entertainment system in a dashboard of the vehicle. The serializer 440 thus may receive digitally demodulated signals from demodulator 430 along with analog demodulated audio from one or more of tuners 420, depending on mode of operation. The serialize 440 may convert these streams into appropriate serial format for communication across a digital bus 445 to head unit 450, e.g., according to an I2S format or any other particular or proprietary standard. Note that while component 440 is described as a serializer for purposes of serializing outgoing serial streams to head unit 450, the component is implemented as a serializer/deserializer, such that it may deserialize incoming (e.g., control) information received via digital bus 445 in the direction from head unit 450 to RTM 410.

The RTM 410 couples to head unit 450 via digital bus 445, which may be implemented as a serial digital bus to communicate analog and digitally demodulated audio and control information. In embodiments, digital bus 445 may be implemented as a bidirectional bus to enable communication of control information from head unit 450 to RTM 410 and further to enable communication of status information in one or both directions, along with the communication of data information from RTM 410 to head unit 450. In an embodiment, digital bus 445 may be implemented with a shielded twisted pair cable. This or another digital cable may be cheaper and lighter weight than corresponding RF cabling that would otherwise be necessary. In addition, such cabling provides crosstalk immunity, and simplifies wiring harnesses and installation. And in embodiments in which multiple RTMs are present, a single shielded twisted pair cable may provide communication between these multiple RTMs and head unit 450, in contrast to inclusion of multiple RF cables, one for each communication path between antenna/LNA combinations (in the absence of an RTM) and head unit 450.

The head unit 450 includes a gateway circuit implemented as a deserializer 455 to receive the incoming information from digital bus 445 and deserialize it. Note that while component 455 is described as a deserializer for purposes of deserializing incoming serial streams from RTM 410, the component is a serializer/deserializer, such that it may serialize outgoing information sent via digital bus 445 in the direction from head unit 450 to RTM 410.

Deserializer 455 couples to a system on chip (SoC) 470, which is a main processor of infotainment system 400. The SoC 470 includes a processing engine 475. Although a single processing engine is shown for ease of illustration, understand that in various implementations, multiple processing engines may be provided. As examples, processing engine 475 may be implemented as one or more general-purpose processor cores, one or more DSPs, and/or one or more other programmable logic circuits.

The processing engine 475 outputs audio signals which may be provided to an optional audio processor 490. Audio processor 490 may perform additional audio processing such as post-processing, balance control, fading, mixing, filtering, equalization, and so forth. In turn, audio processor 490 outputs audio signals to one or more speakers 495.

Moreover, the audio processor 490 or another appropriate component in the receiver unit 108 can perform any of the noise cancellation techniques described herein. For instance, the audio processor 490 can subtract noise detected by the first ground path 122a from the audio signal detected by the first radio frequency antenna 104a. The audio processor 490 can additionally subtract noise detected by the second ground path 122b from the audio signal detected by the second radio frequency antenna 104b. In some implementations, the audio processor can apply noise cancellation by processing some or all the first and second noise signals and the first and second audio signals in combination for noise cancellation. As an example, the audio processor 490 can apply a cancellation algorithm to cancel noise detected from a combination of the first and second ground paths 122a, 122b from one or both of the first audio signal detected by the first radio frequency antenna 104a and a second audio signal detected by the second radio frequency antenna 104b.

SoC 470 is additionally shown to include a radio application 480, which in an embodiment may be a high-level radio application of the system. Radio application 480 may act as an interface to receive user input (e.g., a request for a given radio station) and provide instructions to additional components to provide the requested functionality. To this end, SoC 470 is further shown to include a control application programming interface (API) 482 that acts as a top level of a software stack for the radio functionality. Control API 482 may be configured to communicate with radio application 480 and in turn abstract underlying layers of the radio software stack and the radio hardware. Control API 482 and lower layers of the radio software stack may, in a manner transparent or invisible to radio application 480, handle certain radio functionality such as demodulation functionality in hardware or software depending upon a particular system implementation. That is, while in the illustrated embodiment, audio information is received from RTM 410, is further possible that digital I/Q information instead is received and demodulation operations may be performed within SoC 170, as described further below in another embodiment.

In other embodiments, to remove wiring between remote tuner module 410 and the head unit 450, it is possible for wireless communication to occur between an RTM 410 and the head unit 450. For example, the gateway circuit 445 can be implemented using a wireless interface, and the gateway circuit 455 can include a corresponding wireless interface in the head unit 450, such that wireless communication may occur between RTM 410 and head unit 450 wirelessly, where the link 445 is a wireless link. In various embodiments, communication via wireless link 448 may take different forms, including an IEEE 802.11 or 802.15 wireless communication protocol such as a Bluetooth communication protocol, or one or a variety of different proprietary wireless communication protocols. To this end, wireless interfaces 440, 455 may be implemented as multi-protocol wireless interfaces, such that depending upon a given vehicle into which a system is designed, one of multiple wireless communication protocols may be used. And it is further possible that based on additional wireless communications occurring in the vehicle environment, one of these multiple protocols may be selected, to avoid interference. It is also possible to provide gateway circuits that provide for both wired and wireless communication, such that depending upon operating conditions within a given vehicle, a selected one of a wired or wireless path may be used to provide communication between one or more RTMs and a head unit.

In another implementation, a system designer may choose to not incorporate a hardware demodulator, either in an RTM or within a head unit. Instead in some implementations, demodulation operations may be performed using software.

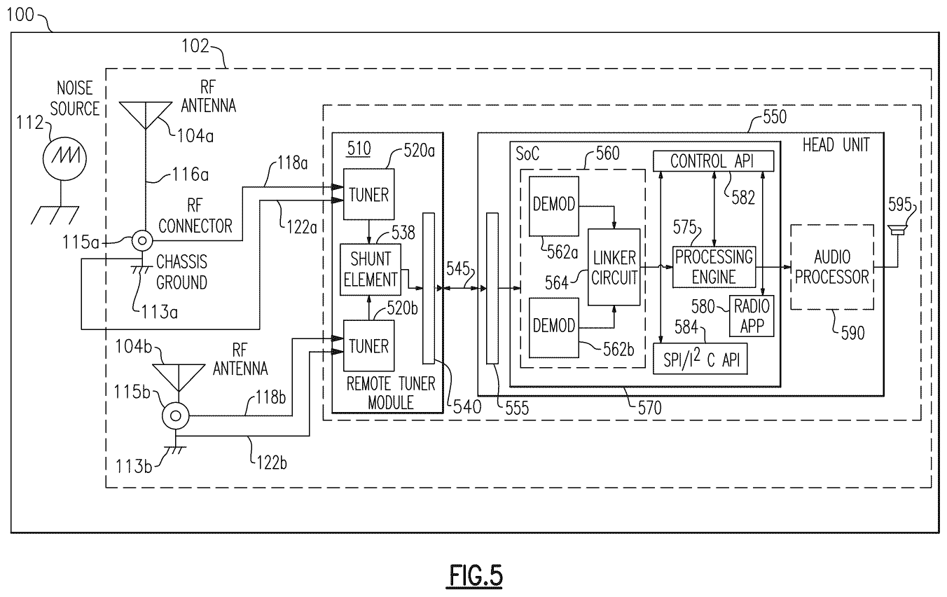

FIG. 5 shows an automobile system 100 in accordance with another embodiment. As illustrated in FIG. 5, an RTM 510 is part of a vehicle radio system 102. In the embodiment of FIG. 5, the RTM 510 does not include a demodulator, unlike the embodiment of FIG. 4. Instead, demodulator functionality is incorporated within the head unit 550, e.g., within an SoC 570, by way of provision of software or firmware code to perform the demodulation functionality. As such RTM 510 is an RTM for SDR, providing analog audio and digital I/Q data. For example, like the audio processor 490 of FIG. 4, the audio processor 590 or another appropriate component in the receiver unit 108 of FIG. 5 can perform any of the noise cancellation techniques described herein, e.g., to subtract noise detected by the first ground path 122a from the audio signal detected by the first radio frequency antenna 104a, and/or subtract noise detected by the second ground path 122b from the audio signal detected by the second radio frequency antenna 104b.

While the RTM 510 lacks demodulator functionality, in other aspects it may be similarly configured as the RTM 410 of FIG. 4 in that it includes multiple tuners 520a, 520b configured to receive incoming radio frequency signals from each of multiple antennas 104a, 104b and multiple ground signal paths 122a, 122b and to process and output information, e.g., as demodulated analog audio or digitally modulated information, e.g., digital IQs of one or more radio formats.

As such, the outputs of each tuner 520a, 520b is coupled to a gateway circuit 540. Like the embodiment of FIG. 4, the gateway circuit 540 can be a serializer configured to received signal information into a serial bitstream for communication to head unit 550, via a link 545. Where the gateway circuit 540 is a serializer, for example, the link 545 can be a serial digital such as a bidirectional high-speed serial bus implemented using a shielded twisted pair cable. In other embodiments, gateway circuit 545 can be implemented using a wireless interface, and the gateway circuit 555 can include a corresponding wireless interface in the head unit 550.

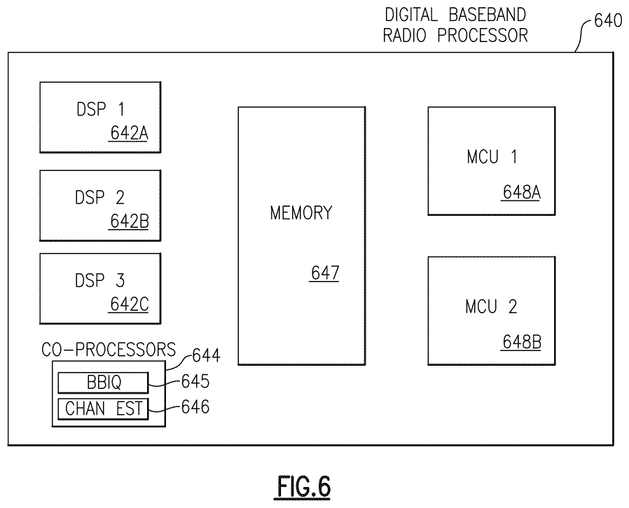

FIG. 6 is a schematic block diagram of a digital radio baseband processor 640 according to an embodiment. As illustrated, the digital radio baseband processor 640 includes a plurality of DSPs 642A, 642B, 642C, a plurality of co-processors 644 including a baseband IQ (BBIQ) co-processor 645 and a channel estimation co-processor 646, a memory 647, and microcontrollers (MCUs) 648A and 648B.

For example, the digital processing circuitry 128 of FIG. 2A, the digital processing circuitry 128 of FIG. 2B, the audio processor 490 of FIG. 4, or the audio processor 590 of FIG. 5 could be implemented in a radio processor like the processor 640 of FIG. 6. For instance, the noise cancellation and other audio processing disclosed herein, e.g., with respect to any of FIGS. 2A-5, can be implemented by one or more of the DSPs 642A, 642B, 642C and/or aided by the one or more of the coprocessors 644.

The noise cancellation disclosed can be implemented in DAB radio system firmware. Noise cancellation disclosed herein can be applied to other digital radio standards, including, but not limited to, NRSC-5C, DRM, and CDR. The noise cancellation systems and techniques disclosed herein is applicable to other suitable OFDM standards including, but not limited to, WiFi and/or other IEEE 802.11 standards, Long Term Evolution (LTE), Digital Video Broadcasting—Terrestrial (DVB-T), etc.

While described in the context of vehicle or automobile radio systems, the systems, devices, and methods described herein can be incorporated into and compatible with other types of environments.

Any of the embodiments described above can be implemented in radio systems. The principles and advantages of the embodiments can be used for any systems or apparatus, such as any radio receiver, which could benefit from any of the embodiments described herein. The teachings herein are applicable to a variety of systems. In certain applications, radio systems disclosed herein are implemented in vehicles such as automobiles. Although this disclosure includes some example embodiments, the teachings described herein can be applied to a variety of structures.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to. ” Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively.

While certain embodiments have been described, these embodiments have been presented by way of example only and are not intended to limit the scope of the disclosure. Indeed, the methods, systems, and circuits described herein may be embodied in a variety of other forms. Furthermore, various omissions, substitutions, and changes in the form of the methods, systems, and circuits described herein may be made without departing from the spirit of the disclosure. Any suitable combination of the elements and/or acts of the various embodiments described above can be combined to provide further embodiments. The accompanying claims and their equivalents are intended to cover such forms or modifications as would fall within the scope and spirit of the disclosure.

What is claimed is:

1. A vehicle radio system comprising:
a radio frequency antenna configured to detect an audio signal;
at least one tuner circuit;
an antenna connector having a first connection coupled to the radio frequency antenna, a second connection coupled to the at least one tuner circuit to provide the audio signal to the at least one tuner circuit, and a third connection coupled to a chassis ground connection of a vehicle;
a ground path extending from the chassis ground connection to the at least one tuner circuit, the ground path configured to detect a noise signal and communicate the noise signal to the at least one tuner circuit; and
an audio processor coupled to the at least one tuner circuit and configured to process the audio signal and the noise signal to generate a noise-reduced audio signal.

2. The vehicle radio system of claim 1 wherein the at least one tuner circuit includes a first tuner circuit and a second tuner circuit, the first tuner circuit coupled to the radio frequency antenna and the second tuner circuit coupled to the ground path.

3. The vehicle radio system of claim 1 wherein the audio processor comprises one or more microprocessors.

4. The vehicle radio system of claim 1 wherein the at least one tuner circuit and the audio processor are included in a common packaging in a radio unit.

5. The vehicle radio system of claim 1 further comprising a remote tuner module including the at least one tuner circuit and further including a head unit having the audio processor.

6. The vehicle radio system of claim 1 further comprising one or more loudspeakers configured to output audible audio in response to the noise-reduced audio signal.

7. The vehicle radio system of claim 1 further comprising a second radio frequency antenna configured to detect a second audio signal, a second antenna connector, and a second ground path, the second antenna connector having a first connection coupled to the second radio frequency antenna, a second connection coupled to the at least one tuner circuit to provide the second audio signal to the at least one tuner circuit, and a third connection coupled to a second chassis ground connection of the vehicle, the second ground path extending from the second chassis ground connection to the at least one tuner circuit.

8. The vehicle radio system of claim 7 wherein the second ground path is configured to detect a second noise signal and communicate the second noise signal to the at least one tuner circuit, and the audio processor is configured to process the audio signal, the second audio signal, the noise signal, and the second noise signal to generate the noise-reduced audio signal.

9. The vehicle radio system of claim 1 wherein the noise signal includes noise generated by one or more of an engine, alternator, motor, or pulse-width-modulated driver of the vehicle.

10. The vehicle radio system of claim 1 wherein the ground path comprises primarily the chassis of the vehicle.

11. A method of reducing noise in an audio signal detected by a vehicle radio system, the method comprising:
detecting an audio signal with a radio frequency antenna of the vehicle radio system;
detecting a noise signal with a ground path that is connected to a ground connection of a vehicle;
communicating the audio signal to at least one tuner circuit of the vehicle radio system;
communicating the noise signal to the at least one tuner circuit via the ground path; and
processing the audio signal and the noise signal with an audio processor to generate a noise-reduced audio signal.

12. The method of claim 11 wherein the at least one tuner circuit includes a first tuner circuit and a second tuner circuit, the first tuner circuit coupled to the radio frequency antenna and the second tuner circuit coupled to the ground path.

13. The method of claim 11 wherein the audio processor comprises one or more microprocessors.

14. The method of claim 11 wherein the at least one tuner circuit and the audio processor are included in a common packaging in a radio unit.

15. The method of claim 11 further comprising a remote tuner module including the at least one tuner circuit and a head unit including the audio processor.

16. The method of claim 11 further comprising outputting audible audio with one or more loudspeakers in response to the noise-reduced audio signal.

17. The method of claim 11 wherein communicating the audio signal to the at least one tuner circuit includes communicating the audio signal from the radio frequency antenna to a first connection of an antenna connector, and communicating the audio signal from a second connection of the antenna connector to the at least one tuner circuit, the antenna connector including a third connection connected to the ground path.

18. The method of claim 11 wherein the ground connection is to a chassis of a vehicle.

19. The method of claim 18 wherein the ground path comprises primarily the chassis of the vehicle.

20. A vehicle radio unit comprising:
at least one tuner circuit configured to receive an audio signal detected by a radio frequency antenna of a vehicle, and to receive a noise signal detected by a ground path connected to a chassis ground connection of the vehicle;
an audio processor coupled to the at least one tuner circuit and configured to process the audio signal and the noise signal to generate a noise-reduced audio signal.
